(19) United States
(12) Patent Application Publication
(10) Pub. No.: US 2017/0357824 A1
(43) Pub. Date: Dec. 14, 2017

(54) DATA PROCESSING SYSTEMS FOR MONITORING MODIFICATIONS TO USER SYSTEM INPUTS TO PREDICT POTENTIAL INPUTS OF INCORRECT OR INCOMPLETE DATA

(71) Applicant: OneTrust, LLC, Atlanta, GA (US)

(72) Inventor: Kabir A. Barday, Atlanta, GA (US)

(21) Appl. No.: 15/619,278

(22) Filed: Jun. 9, 2017

Related U.S. Application Data
(63) Continuation-in-part of application No. 15/254,901, filed on Sep. 1, 2016, now Pat. No. 9,729,583.
(60) Provisional application No. 62/360,123, filed on Jul. 8, 2016.
(60) Provisional application No. 62/353,802, filed on Jun. 23, 2016.
(60) Provisional application No. 62/348,695, filed on Jun. 10, 2016.

(51) Int. Cl. G06F 21/62; G06F 21/57

(52) U.S. Cl. CPC G06F 21/6245; G06F 21/577; G06F 2221/034

(57) ABSTRACT

A privacy compliance monitoring system, according to particular embodiments, is configured to track a user's system inputs and responses to questions regarding a particular privacy campaign in order to monitor any potential abnormal or misleading response. In various embodiments, the system is configured to track changes to a user's responses, monitor an amount of time it takes a user to respond, determine a number of times that a user changes a response and/take other actions to determine whether a particular response may be abnormal. In various embodiments, the system is configured to automatically flag one or more questions based on determining that the user may have provided an abnormal response.

### CROSS REFERENCE TO RELATED APPLICATIONS

This application is a continuation-in-part of U.S. patent application Ser. No. 15/254,901, filed Sep. 1, 2016; and also claims priority to U.S. Provisional Patent Application Ser. No. 62/360,123, filed Jul. 8, 2016; U.S. Provisional Patent Application Ser. No. 62/353,802, filed Jun. 23, 2016; and U.S. Provisional Patent Application Ser. No. 62/348,695, filed Jun. 10, 2016, the disclosures of which are hereby incorporated by reference in their entirety.

### TECHNICAL FIELD

This disclosure relates to, among other things, data processing systems and methods for retrieving data regarding a plurality of privacy campaigns, using that data to assess a relative risk associated with the data privacy campaign, providing an audit schedule for each campaign, monitoring a user's system inputs when providing privacy campaign data, and electronically displaying campaign information.

### BACKGROUND

Over the past years, privacy and security policies, and related operations have become increasingly important. Breaches in security, leading to the unauthorized access of personal data (which may include sensitive personal data) have become more frequent among companies and other organizations of all sizes. Such personal data may include, but is not limited to, personally identifiable information (PII), which may be information that directly (or indirectly) identifies an individual or entity. Examples of PII include names, addresses, dates of birth, social security numbers, and biometric identifiers such as a person's fingerprints or picture. Other personal data may include, for example, customers' Internet browsing habits, purchase history, or even their preferences (e.g., likes and dislikes, as provided or obtained through social media).

Many organizations that obtain, use, and transfer personal data, including sensitive personal data, have begun to address these privacy and security issues. To manage personal data, many companies have attempted to implement operational policies and processes that comply with legal requirements, such as Canada's Personal Information Protection and Electronic Documents Act (PIPEDA) or the U.S.'s Health Insurance Portability and Accountability Act (HIPPA) protecting a patient's medical information. Many regulators recommend conducting privacy impact assessments, or data protection risk assessments along with data inventory mapping. For example, the GDPR requires data protection impact assessments. Additionally, the United Kingdom ICO's office provides guidance around privacy impact assessments. The OPC in Canada recommends certain personal information inventory practices, and the Singapore PDPA specifically mentions personal data inventory mapping.

In implementing these privacy impact assessments, an individual may provide incomplete or incorrect information regarding personal data to be collected, for example, by new software, a new device, or a new business effort, for example, to avoid being prevented from collecting that personal data, or to avoid being subject to more frequent or more detailed privacy audits. In light of the above, there is currently a need for improved systems and methods for monitoring compliance with corporate privacy policies and applicable privacy laws in order to reduce a likelihood that an individual will successfully “game the system” by providing incomplete or incorrect information regarding current or future uses of personal data.

### SUMMARY

A computer-implemented data processing method for monitoring one or more user inputs while a user provides one or more responses to one or more questions in a computerized privacy questionnaire, according to various embodiments, comprises: (A) receiving, by one or more processors, an indication that the user is submitting the one or more responses to the computerized privacy questionnaire; (B) in response to receiving the indication, actively monitoring, by one or more processors, one or more system inputs from the user, the one or more system inputs comprising one or more submitted inputs and one or more unsubmitted inputs; (C) storing, in computer memory, by one or more processors, an electronic record of the one or more system inputs; (D) analyzing, by one or more processors, the one or more submitted inputs and one or more unsubmitted inputs to determine one or more changes to the one or more responses prior to submission, by the user, of the one or more responses; (E) determining, by one or more processors, based at least in part on the one or more inputs and the one or more changes to the one or more responses, whether the user has provided one or more responses comprising one or more abnormal responses; and (F) at least partially in response to determining that the user has provided one or more abnormal responses, automatically flagging the one or more questions in memory.

A computer-implemented data processing method for monitoring one or more system inputs by a user associated with a particular privacy campaign for one or more abnormal inputs, in various embodiments, comprises: (A) receiving the one or more system inputs, from the user, via one or more input devices, wherein the one or more system inputs comprise one or more submitted inputs and one or more unsubmitted inputs; (B) storing, by one or more processors, a record of the one or more system inputs; (C) analyzing, by one or more processors, the one or more submitted inputs and the one or more unsubmitted inputs to determine one or more changes to the one or more inputs; (D) determining, by one or more processors, based at least in part on the one or more system inputs and the one or more changes, whether the one or more system inputs comprise one or more abnormal inputs; and (E) in response to determining that the user has provided one or more abnormal inputs, automatically flagging the one or more inputs in the record of the one or more system inputs.

### BRIEF DESCRIPTION OF THE DRAWINGS

Various embodiments of a system and method for privacy assessment monitoring are described below. In the course of this description, reference will be made to the accompanying drawings, which are not necessarily drawn to scale, and wherein:

FIG. 1 depicts a privacy assessment monitoring system according to particular embodiments.

FIG. 2 is a schematic diagram of a computer (such as the privacy assessment monitoring server 110, or one or more remote computing devices 130) that is suitable for use in various embodiments of the privacy assessment monitoring system shown in FIG. 1.

FIG. 3 is a flow chart showing an example of a process performed by the Privacy Assessment Monitoring Module according to particular embodiments.

FIG. 4 is a flow chart showing an example of a process performed by the Privacy Assessment Modification Module.

FIGS. 5-11 depict exemplary screen displays and graphical user interfaces (GUIs) according to various embodiments of the system, which may display information associated with the system or enable access to or interaction with the system by one or more users.

### DETAILED DESCRIPTION

Various embodiments now will be described more fully with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Overview

In various embodiments, a privacy assessment monitoring system is configured to monitor one or more user inputs related to the provision of information for a particular privacy campaign that may include the collection and/or storage of personal data. The system may, for example, monitor both submitted and un-submitted inputs to determine whether one or more responses submitted by a user in response to one or more questions regarding the particular privacy campaign potentially include one or more abnormal responses.

The privacy assessment monitoring system may be implemented in the context of any suitable privacy compliance system that is configured to ensure compliance with one or more internal, legal or industry standards related to the collection and storage of private information. A particular organization or sub-group may initiate a privacy campaign as part of its business activities. In various embodiments, the privacy campaign may include any undertaking by a particular organization (e.g., such as a project or other activity) that includes the collection, entry, and/or storage (e.g., in memory) of any personal data associated with one or more individuals. This personal data may include, for example, an individual's: (1) name; (2) address; (3) telephone number; (4) e-mail address; (5) social security number; (6) credit account information (e.g., credit card numbers); (7) banking information; (8) location data; (9) internet search history; (10) account data; and/or (11) any other suitable personal information.

As generally discussed above, a particular organization may be required to implement operational policies and processes to comply with one or more legal requirements in handling such personal data. To implement these operational policies, the particular organization may perform one or more privacy impact assessments to assess any potential issues or risks related to the collection and storage of personal data as part of a particular privacy campaign. The one or more privacy impact assessments may include, for example, one or more questionnaires related to, for example: (1) how personal data is stored; (2) for what purpose the personal data is collected; (3) who can access the personal data; (4) why those who have been given access to the personal data were given that access; (5) how long the personal data will be stored; (6) etc.

In various embodiments, the system is configured to display a series of threshold questions for particular privacy campaigns (e.g., as part of a privacy impact assessment) and use conditional logic to assess whether to present additional, follow-up questions to a user. There may be situations in which a user may answer, or attempt to answer, one or more of the threshold questions incorrectly (e.g., dishonestly) in an attempt to avoid needing to answer additional questions. This type of behavior can present serious potential problems for the organization because the behavior may result in privacy risks associated with a particular privacy campaign being hidden due to the incorrect answer or answers.

To address this issue, in various embodiments, the system: (1) maintains a historical record of every button press that an individual makes when a question is presented to them; and (2) tracks, and saves to memory, each incidence of the individual changing their answer to each respective question (e.g., before formally submitting the answer by pressing an “enter” key, or other “submit” key on a user interface, such as a keyboard or graphical user interface on a touch-sensitive display screen, or after initially submitting the answer).

The system may also be adapted to automatically determine whether a particular question (e.g., threshold question) is a “critical” question that, if answered in a certain way, would cause a conditional logic trigger to present the user with one or more follow-up questions. For example, the system may, in response to receiving the user's full set of answers to the threshold questions, automatically identify any individual question within the series of threshold questions that, if answered in a particular way (e.g., differently than the user answered the question) would have caused the system to display one or more follow up questions. The system may then flag those identified questions, in the system's memory, as “critical” questions.

Alternatively, the system may be adapted to allow a user (e.g., a privacy officer of an organization) who is drafting a particular threshold question that, when answered in a particular way, will automatically trigger the system to display one or more follow up questions to the user, to indicate that the question is a “critical” threshold question. The system may then save this “critical” designation of the question to the system's computer memory.

In various embodiments, the system is configured, for each question that is deemed “critical” (e.g., either by the system, or manually, as discussed above), to determine whether the user exhibited any abnormal behavior when answering the question. For example, the system may check to see whether the user changed their answer once, or multiple times, before submitting their answer to the question (e.g., by tracking the user's keystrokes or other system inputs while the user is answering the threshold question, as described above). As another example, the system may determine whether it took the user longer than a pre-determined threshold amount of time (e.g., 5 minutes, 3 minutes, etc.) to answer the critical threshold question.

The system may be adapted, in response to determining that the user exhibited abnormal behavior when answering a critical threshold question, to automatically flag the threshold question and the user's answer to that question for later follow up by a designated individual or team (e.g., a member of the organization's privacy team). The system may also, or alternatively, be adapted to automatically generate and transmit a message to one or more individuals (e.g., the organization's chief privacy officer) indicating that the threshold question may have been answered incorrectly and that follow-up regarding the question may be advisable. After receiving the message, the individual may follow up with the individual who answered the question, or conduct additional research, to determine whether the question was answered accurately. The system may also be configured to automatically modify a questionnaire to include one or more additional questions in response to determining that a user may have answered a particular question abnormally.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

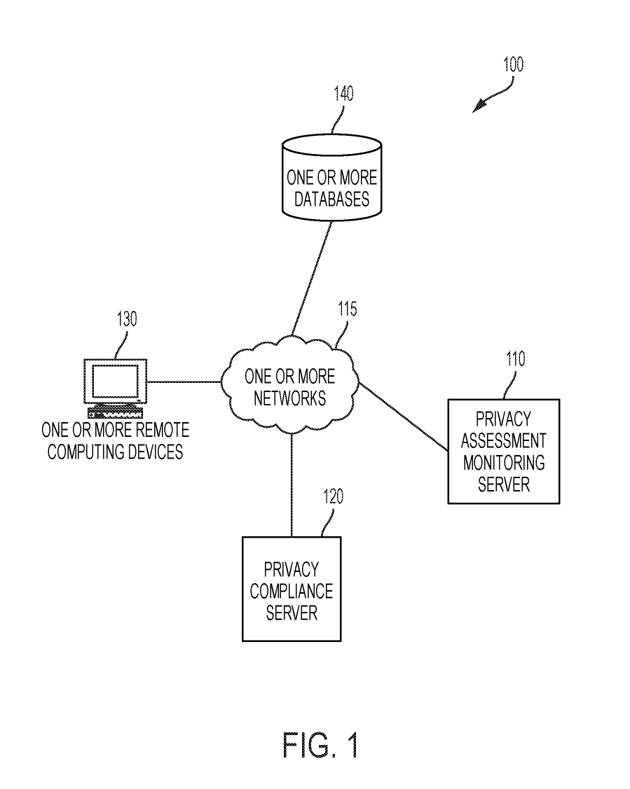

FIG. 1 is a block diagram of a Privacy Assessment Monitoring System 100 according to a particular embodiment. In various embodiments, the Privacy Assessment Monitoring System 100 is part of a Privacy Compliance System, or a plurality of Privacy Compliance Systems, which may each be associated with a respective particular organization. In various embodiments, each particular Privacy Compliance System may be associated with a respective particular organization and be configured to manage one or more privacy campaigns, projects, or other activities associated with the particular organization. In some embodiments, the Privacy Assessment Monitoring System 100 is configured to interface with at least a portion of each respective organization's Privacy Compliance System in order to determine whether a user may have provided one or more abnormal responses as part of a questionnaire related to a particular privacy campaign.

As may be understood from FIG. 1, the Privacy Assessment Monitoring System 100 includes one or more computer networks 115, a Privacy Assessment Monitoring Server 110, a Privacy Compliance Server 120, one or more remote computing devices 130 (e.g., a desktop computer, laptop computer, tablet computer, etc.), and one or more databases 140. In particular embodiments, the one or more computer networks 115 facilitate communication between the Privacy Assessment Monitoring Server 110, Privacy Compliance Server 120, one or more remote computing devices 130 (e.g., a desktop computer, laptop computer, tablet computer, etc.), and one or more databases 140.

The one or more computer networks 115 may include any of a variety of types of wired or wireless computer networks such as the Internet, a private intranet, a public switch telephone network (PSTN), or any other type of network. The communication link between Privacy Assessment Monitoring Server 110 and Database 140 may be, for example, implemented via a Local Area Network (LAN) or via the Internet.

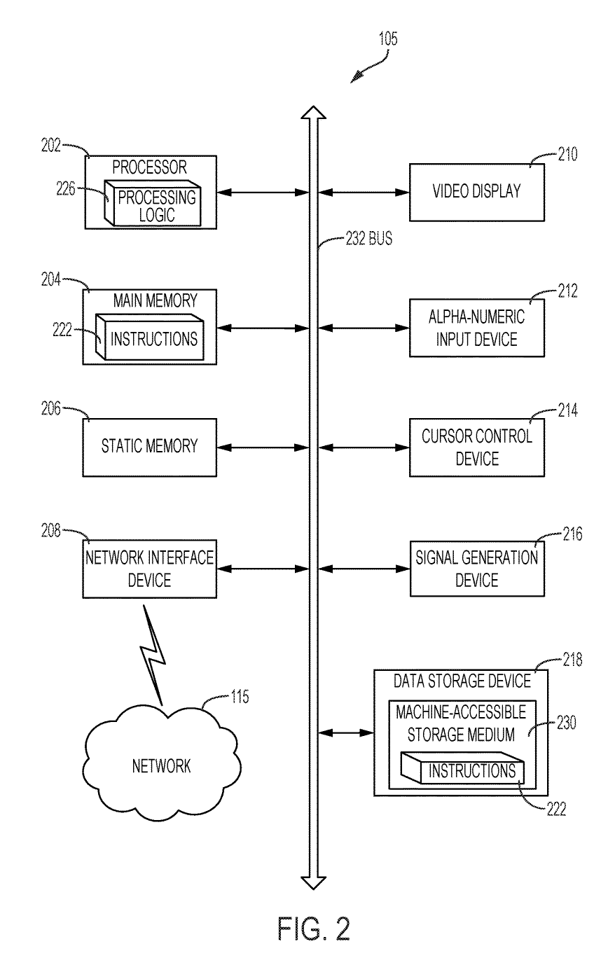

FIG. 2 illustrates a diagrammatic representation of a computer 200 that can be used within the Privacy Assessment Monitoring System 100, for example, as a client computer (e.g., one or more remote computing devices 130 shown in FIG. 1), or as a server computer (e.g., Privacy Assessment Monitoring Server 110 shown in FIG. 1). In particular embodiments, the computer 200 may be suitable for use as a computer within the context of the Privacy Assessment Monitoring System 100 that is configured to monitor a user's system inputs to ascertain whether any of those inputs are abnormal. In various embodiments, the system is configured to monitor whether the user's inputs may be indicative of the user attempting to game the system.

In particular embodiments, the computer 200 may be connected (e.g., networked) to other computers in a LAN, an intranet, an extranet, and/or the Internet. As noted above, the computer 200 may operate in the capacity of a server or a client computer in a client-server network environment, or as a peer computer in a peer-to-peer (or distributed) network environment. The Computer 200 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 200 includes a processing device 202, a main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 200 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software instructions 222) embodying any one or more of the methodologies or functions described herein. The software instructions 222 may also reside, completely or at least partially, within main memory 204 and/or within processing device 202 during execution thereof by computer 200—main memory 204 and processing device 202 also constituting computer-accessible storage media. The software instructions 222 may further be transmitted or received over a network 115 via network interface device 208.

While the computer-accessible storage medium 230 is shown in an exemplary embodiment to be a single medium, the term “computer-accessible storage medium” (or like terms, such as “computer-readable medium”) should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium”, and like terms, should accordingly be understood to include, but not be limited to, solid-state memories, optical and magnetic media, etc.

### Exemplary System Platform

Various embodiments of a privacy assessment monitoring system may be implemented in the context of any suitable privacy compliance system. For example, the privacy assessment monitoring system may be implemented to monitor a user's system inputs during the initiation of a new privacy campaign or responses to one or more questions related to a privacy impact assessment for a privacy campaign. The system may, for example, be configured to monitor the user's system inputs, determine whether the user has provided one or more abnormal responses or inputs based on their monitored inputs, and take one or more actions in response to determining that the user has provided one or more abnormal answers. Various aspects of the system's functionality may be executed by certain system modules, including a Privacy Assessment Monitoring Module 300 and Privacy Assessment Modification Module 400. These modules are discussed in greater detail below. Although these modules are presented as a series of steps, it should be understood in light of this disclosure that various embodiments of the various modules described herein may perform the steps described below in an order other than in which they are presented. In still other embodiments, any module described herein may omit certain steps described below. In still other embodiments, any module described herein may perform steps in addition to those described.

### Privacy Assessment Monitoring Module

In particular embodiments, a Privacy Assessment Monitoring Module 300 is configured to: (1) monitor user inputs when the user is providing information related to a privacy campaign or completing a privacy impact assessment; and (2) determine, based at least in part on the user inputs, whether the user has provided one or more abnormal inputs or responses. In various embodiments, the Privacy Assessment Monitoring Module 300 is configured to determine whether the user is, or may be, attempting to provide incomplete, false, or misleading information or responses related to the creation of a particular privacy campaign, a privacy impact assessment associated with a particular privacy campaign, etc.

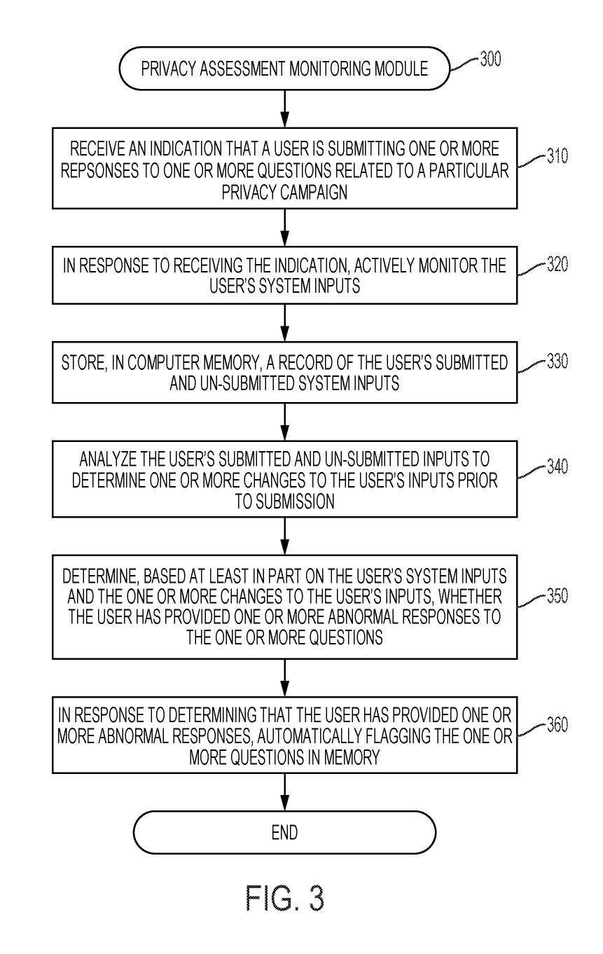

Turning to FIG. 3, in particular embodiments, when executing the Privacy Assessment Monitoring Module 300, the system begins, at Step 310, by receiving an indication that a user is submitting one or more responses to one or more questions related to a particular privacy campaign. In various embodiments, the system is configured to receive the indication in response to a user initiating a new privacy campaign (e.g., on behalf of a particular organization, sub-group within the organization, or other suitable business unit). In other embodiments, the system is configured to receive the indication while a particular user is completing a privacy impact assessment for a particular privacy campaign, where the privacy impact assessment provides oversight into various aspects of the particular privacy campaign such as, for example: (1) what personal data is collected as part of the privacy campaign; (2) where the personal data is stored; (3) who has access to the stored personal data; (4) for what purpose the personal data is collected, etc.

In various embodiments, the system is configured to receive the indication in response to determining that a user has accessed a privacy campaign initiation system (e.g., or other privacy system) and is providing one or more pieces of information related to a particular privacy campaign. In particular embodiments, the system is configured to receive the indication in response to the provision, by the user, of one or more responses as part of a privacy impact assessment. In various embodiments, the system is configured to receive the indication in response to any suitable stimulus in any situation in which a user may provide one or more potentially abnormal responses to one or more questions related to the collection, storage or use of personal data.

In various embodiments, the privacy campaign may be associated with an electronic record (e.g., or any suitable data structure) comprising privacy campaign data. In particular embodiments, the privacy campaign data comprises a description of the privacy campaign, one or more types of personal data related to the campaign, a subject from which the personal data is collected as part of the privacy campaign, a storage location of the personal data (e.g., including a physical location of physical memory on which the personal data is stored), one or more access permissions associated with the personal data, and/or any other suitable data associated with the privacy campaign. In various embodiments, the privacy campaign data is provided by a user of the system.

An exemplary privacy campaign, project, or other activity may include, for example: (1) a new IT system for storing and accessing personal data (e.g., include new hardware and/or software that makes up the new IT system; (2) a data sharing initiative where two or more organizations seek to pool or link one or more sets of personal data; (3) a proposal to identify people in a particular group or demographic and initiate a course of action; (4) using existing data for a new and unexpected or more intrusive purpose; and/or (5) one or more new databases which consolidate information held by separate parts of the organization. In still other embodiments, the particular privacy campaign, project or other activity may include any other privacy campaign, project, or other activity discussed herein, or any other suitable privacy campaign, project, or activity.

During a privacy impact assessment for a particular privacy campaign, a privacy impact assessment system may ask one or more users (e.g., one or more individuals associated with the particular organization or sub-group that is undertaking the privacy campaign) a series of privacy impact assessment questions regarding the particular privacy campaign and then store the answers to these questions in the system's memory, or in memory of another system, such as a third-party computer server.

Such privacy impact assessment questions may include questions regarding, for example: (1) what type of data is to be collected as part of the campaign; (2) who the data is to be collected from; (3) where the data is to be stored; (4) who will have access to the data; (5) how long the data will be kept before being deleted from the system's memory or archived; and/or (6) any other relevant information regarding the campaign. In various embodiments a privacy impact assessment system may determine a relative risk or potential issues with a particular privacy campaign as it related to the collection and storage of personal data. For example, the system may be configured to identify a privacy campaign as being “High” risk, “Medium” risk, or “Low” risk based at least in part on answers submitted to the questions listed above. For example, a Privacy Impact Assessment that revealed that credit card numbers would be stored without encryption for a privacy campaign would likely cause the system to determine that the privacy campaign was high risk.

As may be understood in light of this disclosure, a particular organization may implement operational policies and processes that strive to comply with industry best practices and legal requirements in the handling of personal data. In various embodiments, the operational policies and processes may include performing privacy impact assessments (e.g., such as those described above) by the organization and/or one or more sub-groups within the organization. In particular embodiments, one or more individuals responsible for completing a privacy impact assessment or providing privacy campaign data for a particular privacy campaign may attempt to provide abnormal, misleading, or otherwise incorrect information as part of the privacy impact assessment. In such embodiments, the system may be configured to receive the indication in response to receiving an indication that a user has initiated or is performing a privacy impact assessment.

Returning to Step 320, the system is configured to, in response to receiving the indication at Step 310, monitor (e.g., actively monitor) the user's system inputs. In particular embodiments, actively monitoring the user's system inputs may include, for example, monitoring, recording, tracking, and/or otherwise taking account of the user's system inputs. These system inputs may include, for example: (1) one or more mouse inputs; (2) one or more keyboard (e.g., text) inputs); (3) one or more touch inputs; and/or (4) any other suitable inputs (e.g., such as one or more vocal inputs, etc.). In various embodiments, the system is configured to actively monitor the user's system inputs, for example: (1) while the user is viewing one or more graphical user interfaces for providing information regarding or responses to questions regarding one or more privacy campaigns; (2) while the user is logged into a privacy portal; and/or (3) in any other suitable situation related to the user providing information related to the collection or storage of personal data (e.g., in the context of a privacy campaign). In other embodiments, the system is configured to monitor one or more biometric indicators associated with the user such as, for example, heart rate, pupil dilation, perspiration rate, etc.

In particular embodiments, the system is configured to monitor a user's inputs, for example, by substantially automatically tracking a location of the user's mouse pointer with respect to one or more selectable objects on a display screen of a computing device. In particular embodiments, the one or more selectable objects are one or more selectable objects (e.g., indicia) that make up part of a particular privacy impact assessment, privacy campaign initiation system, etc. In still other embodiments, the system is configured to monitor a user's selection of any of the one or more selectable objects, which may include, for example, an initial selection of one or more selectable objects that the user subsequently changes to selection of a different one of the one or more selectable objects.

In any embodiment described herein, the system may be configured to monitor one or more keyboard inputs (e.g., text inputs) by the user that may include, for example, one or more keyboard inputs that the user enters or one or more keyboard inputs that the user enters but deletes without submitting. For example, a user may type an entry relating to the creation of a new privacy campaign in response to a prompt that asks what reason a particular piece of personal data is being collected for. The user may, for example, initially begin typing a first response, but delete the first response and enter a second response that the user ultimately submits. In various embodiments of the system described herein, the system is configured to monitor the un-submitted first response in addition to the submitted second response.

In still other embodiments, the system is configured to monitor a user's lack of input. For example, a user may mouse over a particular input indicia (e.g., a selection from a drop-down menu, a radio button or other selectable indicia) without selecting the selection or indicia. In particular embodiments, the system is configured to monitor such inputs. As may be understood in light of this disclosure, a user that mouses over a particular selection and lingers over the selection without actually selecting it may be contemplating whether to: (1) provide a misleading response; (2) avoid providing a response that they likely should provide in order to avoid additional follow up questions; and/or (3) etc.

In other embodiments, the system is configured to monitor any other suitable input by the user. In various embodiments, this may include, for example: (1) monitoring one or more changes to an input by a user; (2) monitoring one or more inputs that the user later removes or deletes; (3) monitoring an amount of time that the user spends providing a particular input; and/or (4) monitoring or otherwise tracking any other suitable information related to the user's response to a particular question and/or provision of a particular input to the system.

Retuning to Step 330, the system is configured to store, in memory, a record of the user's submitted and un-submitted system inputs. As discussed above, the system may be configured to actively monitor both submitted and un-submitted inputs by the user. In particular embodiments, the system is configured to store a record of those inputs in computer memory (e.g., in the One or More Databases 140 shown in FIG. 1). In particular embodiments, storing the user's submitted and un-submitted system inputs may include, for example, storing a record of: (1) each system input made by the user; (2) an amount of time spent by the user in making each particular input; (3) one or more changes to one or more inputs made by the user; (4) an amount of time spent by the user to complete a particular form or particular series of questions prior to submission; and/or (5) any other suitable information related to the user's inputs as they may relate to the provision of information related to one or more privacy campaigns.

Continuing to Step 340, the system is configured to analyze the user's submitted and un-submitted inputs to determine one or more changes to the user's inputs prior to submission. In particular embodiments, the system may, for example: (1) compare a first text input with a second text input to determine one or more differences, where the first text input is an unsubmitted input and the second text input is a submitted input; (2) determine one or more changes in selection, by the user, of a user-selectable input indicia (e.g., including a number of times the user changed a selection); and/or (3) compare any other system inputs by the user to determine one or more changes to the user's responses to one or more questions prior to submission. In various embodiments, the system is configured to determine whether the one or more changes include one or more changes that alter a meaning of the submitted and unsubmitted inputs.

In various embodiments, the system is configured to compare first, unsubmitted text input with second, submitted text input to determine whether the content of the second text input differs from the first text input in a meaningful way. For example, a user may modify the wording of their text input without substantially modifying the meaning of the input (e.g., to correct spelling, utilize one or more synonyms, correct punctuation, etc.). In this example, the system may determine that the user has not made meaningful changes to their provided input.

In another example, the system may determine that the user has changed the first input to the second input where the second input has a meaning that differs from a meaning of the first input. For example, the first and second text inputs may: (1) list one or more different individuals; (2) list one or more different storage locations; (3) include one or more words with opposing meanings (e.g., positive vs. negative, short vs. long, store vs. delete, etc.); and/or (4) include any other differing text that may indicate that the responses provided (e.g., the first text input and the second text input) do not have essentially the same meaning. In this example, the system may determine that the user has made one or more changes to the user's inputs prior to submission.

Returning to Step 350, the system continues by determining, based at least in part on the user's system inputs and the one or more changes to the user's inputs, whether the user has provided one or more abnormal responses to the one or more questions. In various embodiments, the system is configured to determine whether the user has provided one or more abnormal responses to the one or more questions based on determining, at Step 340, that the user has made one or more changes to a response prior to submitting the response (e.g., where the one or more changes alter a meaning of the response).

In other embodiments, the system is configured to determine that the user has provided one or more abnormal responses based on determining that the user took longer than a particular amount of time to provide a particular response. For example, the system may determine that the user has provided an abnormal response in response to the user taking longer than a particular amount of time (e.g., longer than thirty seconds, longer than one minute, longer than two minutes, etc.) to answer a simple multiple choice question (e.g., “Will the privacy campaign collect personal data for customers or employees?”).

In particular embodiments, the system is configured to determine that the user has provided one or more abnormal responses based on a number of times that the user has changed a response to a particular question. For example, the system may determine a number of different selections made by the user when selecting one or more choices from a drop down menu prior to ultimately submitting a response. In another example, the system may determine a number of times the user changed their free-form text entry response to a particular question. In various embodiments, the system is configured to determine that the user provided one or more abnormal responses in response to determining that the user changed their response to a particular question more than a threshold number of times (e.g., one time, two times, three times, four times, five times, etc.).

In still other embodiments, the system is configured to determine that the user has provided one or more abnormal responses based at least in part on whether a particular question (e.g., threshold question) is a “critical” question. In particular embodiments, a critical question may include a question that, if answered in a certain way, would cause the system's conditional logic trigger to present the user with one or more follow-up questions. For example, the system may, in response to receiving the user's full set of answers to the threshold questions, automatically identify any individual question within the series of threshold questions that, if answered in a particular way (e.g., differently than the user answered the question) would have caused the system to display one or more follow up questions.

In various embodiments, the system is configured, for any questions that are deemed “critical” (e.g., either by the system, or manually) to determine whether the user exhibited any abnormal behavior when answering the question. For example, the system may check to see whether the user changed their answer once, or multiple times, before submitting their answer to the question (e.g., by tracking the user's keystrokes or other system inputs while they are answering the threshold question, as described above). As another example, the system may determine whether it took the user longer than a pre-determined threshold amount of time (e.g., 5 minutes, 3 minutes, etc.) to answer the critical threshold question.

In particular embodiments, the system is configured to determine whether the user provided one or more abnormal responses based on any suitable combination of factors described herein including, for example: (1) one or more changes to a particular response; (2) a number of changes to a particular response; (3) an amount of time it took to provide the particular response; (4) whether the response is a response to a critical question; and/or (5) any other suitable factor.

Continuing to Step 360, the system, in response to determining that the user has provided one or more abnormal responses, automatically flags the one or more questions in memory. In particular embodiments, the system is configured to automatically flag the one or more questions in memory by associating the one or more questions in memory with a listing or index of flagged questions. In other embodiments, the system, in response to flagging the one or more questions, is further configured to generate a notification and transmit the notification to any suitable individual. For example, the system may transmit a notification that one or more question have been flagged by a particular privacy officer or other individual responsible ensuring that a particular organization's collection and storage of personal data meets one or more legal or industry standards.

In particular embodiments, the system is configured to generate a report of flagged questions related to a particular privacy campaign. In various embodiments, flagging the one or more questions is configured to initiate a follow up by a designated individual or team (e.g., a member of the organization's privacy team) regarding the one or more questions. In particular embodiments, the system may also, or alternatively, be adapted to automatically generate and transmit a message to one or more individuals (e.g., the organization's chief privacy officer) indicating that the threshold question may have been answered incorrectly and that follow-up regarding the question may be advisable. After receiving the message, the individual may, in particular embodiments, follow up with the individual who answered the question, or conduct other additional research, to determine whether the question was answered accurately.

### Privacy Assessment Modification Module

In particular embodiments, a Privacy Assessment Modification Module 400 is configured to modify a questionnaire to include at least one additional question in response to determining that a user has provided one or more abnormal inputs or responses regarding a particular privacy campaign. For example, the system may, as discussed above, prompt the user to answer one or more follow up questions in response to determining that the user gave an abnormal response to a critical question. In particular embodiments, modifying the questionnaire to include one or more additional questions may prompt the user to provide more accurate responses which may, for example, limit a likelihood that a particular privacy campaign may run afoul of legal or industry-imposed restrictions on the collection and storage of personal data.

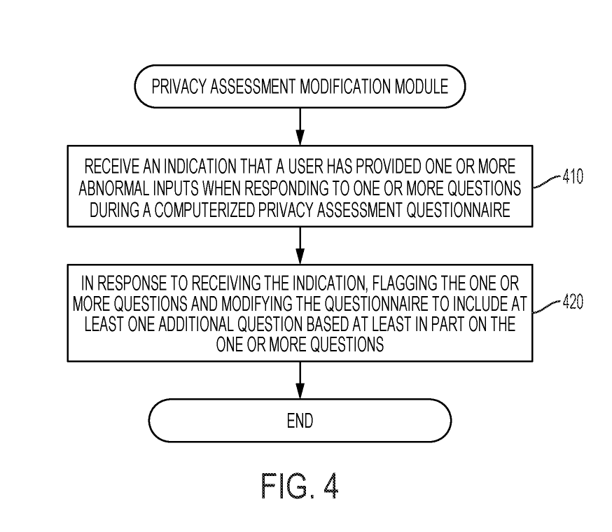

Turning to FIG. 4, in particular embodiments, when executing the Privacy Assessment Modification Module 400, the system begins, at Step 410, by receiving an indication that a user has provided one or more abnormal inputs or responses to one or more questions during a computerized privacy assessment questionnaire. In particular embodiments, the system is configured to receive the indication in response to determining that the user has provided one or more abnormal responses to one or more questions as part of Step 350 of the Privacy Assessment Monitoring Module 300 described above.

Continuing to Step 420, in response to receiving the indication, the system is configured to flag the one or more questions and modify the questionnaire to include at least one additional question based at least in part on the one or more questions. In various embodiments, the system is configured to modify the questionnaire to include at least one follow up question that relates to the one or more questions for which the user provided one or more abnormal responses. For example, the system may modify the questionnaire to include one or more follow up questions that the system would have prompted the user to answer if the user had submitted a response that the user had initially provided but not submitted. For example, a user may have initially provided a response that social security numbers would be collected as part of a privacy campaign but deleted that response prior to submitting what sort of personal data would be collected. The system may, in response to determining that the user had provided an abnormal response to that question, modify the questionnaire to include one or more additional questions related to why social security numbers would need to be collected (or to double check that they, in fact, would not be).

In other embodiments, the system is configured to take any other suitable action in response to determining that a user has provided one or more abnormal responses. The system may, for example: (1) automatically modify a privacy campaign; (2) flag a privacy campaign for review by one or more third party regulators; and/or (3) perform any other suitable action.

### Exemplary User Experience

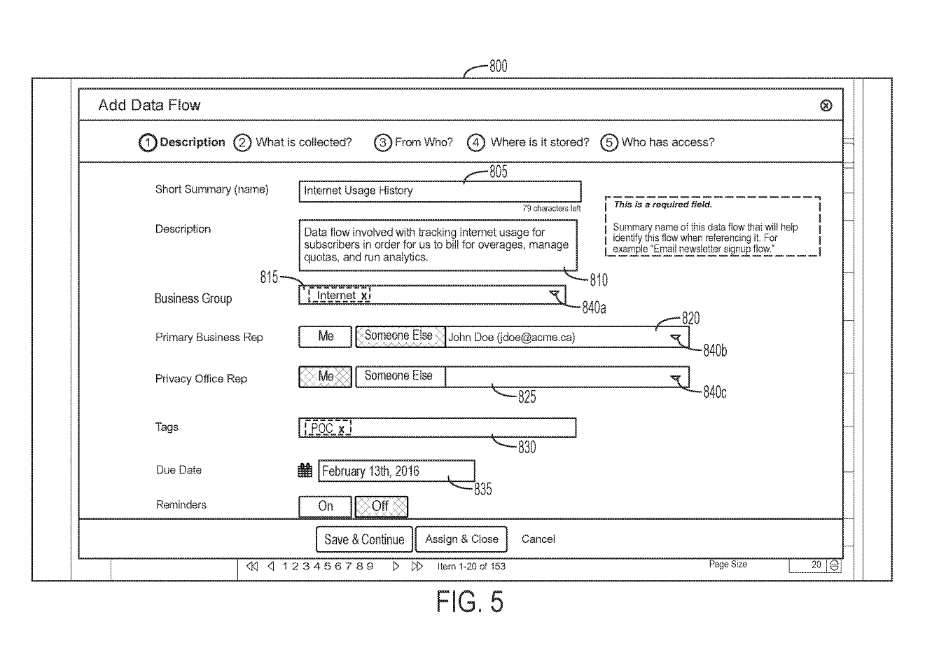

In exemplary embodiments of a privacy assessment monitoring system, a user may access a privacy compliance system, for example: (1) to initiate a new privacy campaign; and/or (2) to perform and/or complete a privacy impact assessment. For example, a user that is part of a particular organization may log in to a suitable privacy compliance system, for example, via a suitable graphical user interface via which the user may provide information to the system regarding one or more privacy campaigns. FIGS. 5-11 depict exemplary screen displays of a privacy compliance system and a privacy compliance monitoring system according to particular embodiments. As may be understood from these figures in light of this disclosure, a privacy compliance system may provide access to the privacy compliance system (e.g., to an individual associated with an organization) via one or more GUIs with which the individual may: (1) initiate a new privacy campaign, project, or other activity; (2) modify an existing privacy campaign; (3) perform one or more privacy impact assessments, etc.

The one or more GUIs may enable the individual to, for example, provide information such as: (1) a description of the campaign; (2) the personal data to be collected as part of the campaign; (3) who the personal data relates to; (4) where the personal data is to be stored; and (5) who will have access to the indicated personal data, etc. Various embodiments of a system for implementing and auditing a privacy campaign are described in U.S. patent application Ser. No. 15/169,643, filed May 31, 2016 entitled “Data Processing Systems and Methods for Operationalizing Privacy Compliance and Assessing the Risk of Various Respective Privacy Campaigns”, which is hereby incorporated herein in its entirety. In particular embodiments, the system is further configured to use one or more privacy assessment monitoring systems to monitor, record and/or analyze the user's systems inputs while the user is accessing the privacy compliance system. In various embodiments, the privacy assessment monitoring system may be embodied as, for example: (1) a browser plugin; (2) computer code configured to run in the background of the privacy compliance system as the user is accessing the privacy compliance system; (3) a monitoring system integrated with the privacy compliance system; and/or (4) any other suitable system for monitoring user inputs. These exemplary screen displays and user experiences according to particular embodiments are described more fully below.

A. FIG. 5: Initiating a New Privacy Campaign, Project, or Other Activity

FIG. 5 illustrates an exemplary screen display with which a user may initiate a new privacy campaign, project, or other activity. As may be understood in light of this disclosure, the system may be configured to actively monitor a user's inputs while the user enters data during the initiation of a new privacy campaign. As may be further understood from this disclosure, the system may utilize the user's inputs to determine whether the user has provided one or more pieces of data related to the privacy campaign which may be abnormal (e.g., which may include misleading on incorrect information related to the privacy campaign).

As shown in FIG. 5, a description entry dialog 800 may have several fillable/editable fields and/or drop-down selectors. In this example, the user may fill out the name of the campaign (e.g., project or activity) in the Short Summary (name) field 805, and a description of the campaign in the Description field 810. As the user is filling out the description of the campaign, the system may, for example: (1) monitor one or more changes to the description entered by the user; (2) monitor one or more portions of the description that the user enters but later deletes; (3) monitor an amount of time that the user spends entering the description; and/or (4) monitor or otherwise track any other suitable information related to the user's entry of the description. The user may enter or select the name of the business group (or groups) that will be accessing personal data for the campaign in the Business Group field 815 (i.e., the “Internet” business group in this example). The user may select the primary business representative responsible for the campaign (i.e., the campaign's owner), and designate him/herself, or designate someone else to be that owner by entering that selection through the Someone Else field 820. Similarly, the user may designate him/herself as the privacy office representative owner for the campaign, or select someone else from the second Someone Else field 825. As with entering the description in the Description field 810, the system may be configured to monitor the user's inputs related to the name of the business group (or groups) that will be accessing personal data for the campaign as well as the primary business representative. As may be understood in light of this disclosure, the system may be configured to track the user's inputs via the user interface shown in FIG. 5 in a discreet manner (e.g., in a manner in which the tracking of inputs is not apparent to the user in that the system produces or displays no notification of the tracking or indication in response to the system determining that any of the user inputs are abnormal or problematic).

At any point, a user assigned as the owner may also assign others the task of selecting or answering any question related to the campaign. The user may also enter one or more tag words associated with the campaign in the Tags field 830. After entry, the tag words may be used to search for campaigns, or used to filter for campaigns (for example, under Filters 845). The user may assign a due date for completing the campaign entry, and turn reminders for the campaign on or off. The user may save and continue, or assign and close. In particular embodiments the system is configured to monitor and store information related to any of one or more user inputs prior to selection, by the user, of the “save & continue” or “assign and close” indicia.

In example embodiments, some of the fields may be filled in by a user, with suggest-as-you-type display of possible field entries (e.g., Business Group field 815), and/or may include the ability for the user to select items from a drop-down selector (e.g., drop-down selectors 840a, 840b, 840c). In such embodiments, the system may be configured to track a position of a pointer device (e.g., computer mouse) that the user is using to access and interact with the user interface shown in FIG. 5. In this way, the system may, for example: (1) monitor and record information related to one or more changes to a user's selection of an item from a drop-down selector; (2) monitor and record a location of the pointer device relative to the user interface to determine whether the user leaves the pointer device over an ultimately-unselected option longer than a particular amount of time (e.g., two seconds, five seconds, ten seconds, etc.); (3) monitor an amount of time a user spends selecting an item from a drop-down selector; and/or (4) monitor any other suitable information related to the user's interaction with a drop-down selector. The system may also allow some fields to stay hidden or unmodifiable to certain designated viewers or categories of users. For example, the purpose behind a campaign may be hidden from anyone who is not the chief privacy officer of the company, or the retention schedule may be configured so that it cannot be modified by anyone outside of the organization's' legal department.

In various embodiments, when initiating a new privacy campaign, project, or other activity (e.g., or modifying an existing one), the user associated with the organization may set a Due Date 835 that corresponds to a date by which the privacy campaign needs to be approved by a third-party regulator (e.g., such that the campaign may be approved prior to launching the campaign externally and/or beginning to collect data as part of the campaign). In various embodiments, the system may limit the proximity of a requested Due Date 835 to a current date based on a current availability of third-party regulators and/or whether the user has requested expedited review of the particular privacy campaign.

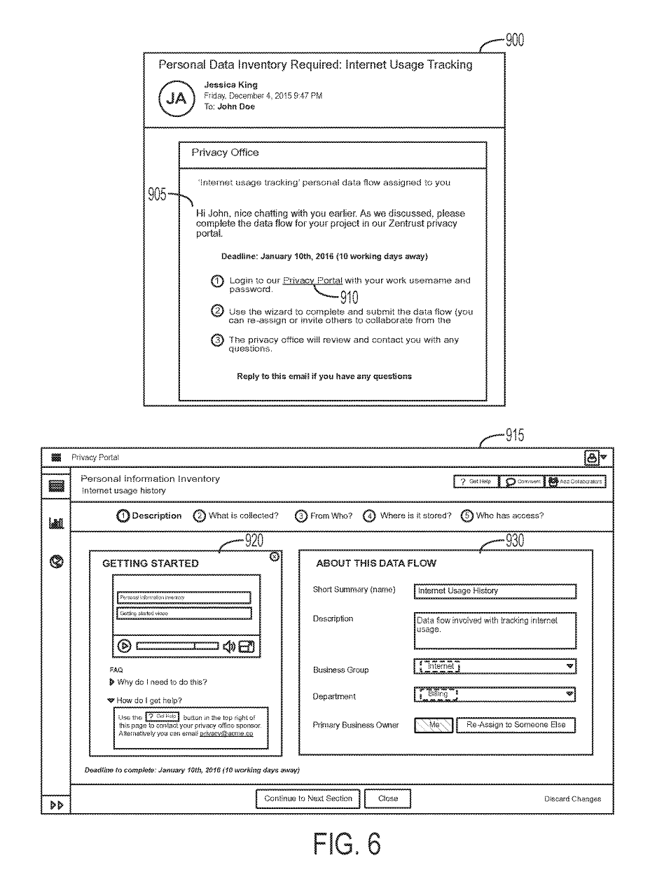

B. FIG. 6: Collaborator Assignment Notification and Description Entry

Moving to FIG. 6, in example embodiments, if another business representative (owner), or another privacy office representative has been assigned to the campaign (e.g., John Doe in FIG. 5), the system may send a notification (e.g., an electronic notification) to the assigned individual, letting them know that the campaign has been assigned to him/her. FIG. 6 shows an example notification 900 sent to John Doe that is in the form of an email message. The email informs him that the campaign “Internet Usage Tracking” has been assigned to him, and provides other relevant information, including the deadline for completing the campaign entry and instructions to log in to the system to complete the campaign (data flow) entry (which may be done, for example, using a suitable “wizard” program). The user that assigned John ownership of the campaign may also include additional comments 905 to be included with the notification 900. Also included may be an option to reply to the email if an assigned owner has any questions.

In this example, if John selects the hyperlink Privacy Portal 910, he is able to access the system, which displays a landing page 915. In various embodiments, the system is configured to receive the indication that a user is submitting one or more responses to one or more questions related to a privacy campaign, described above with respect to Step 310 of the Privacy Assessment Monitoring Module 300, in response to selection, by the user John, of the Privacy Portal 910 hyperlink.

The landing page 915 of the Privacy Portal 910 hyperlink displays a Getting Started section 920 to familiarize new owners with the system, and also display an “About This Data Flow” section 930 showing overview information for the campaign. As may be understood in light of this disclosure, in response to accessing the Privacy Portal 910 for the particular privacy campaign by John Doe, the system may be configured to begin actively monitoring the user's system inputs (e.g., include keyboard inputs, mouse inputs, touch inputs, etc. via the user interfaces shown).

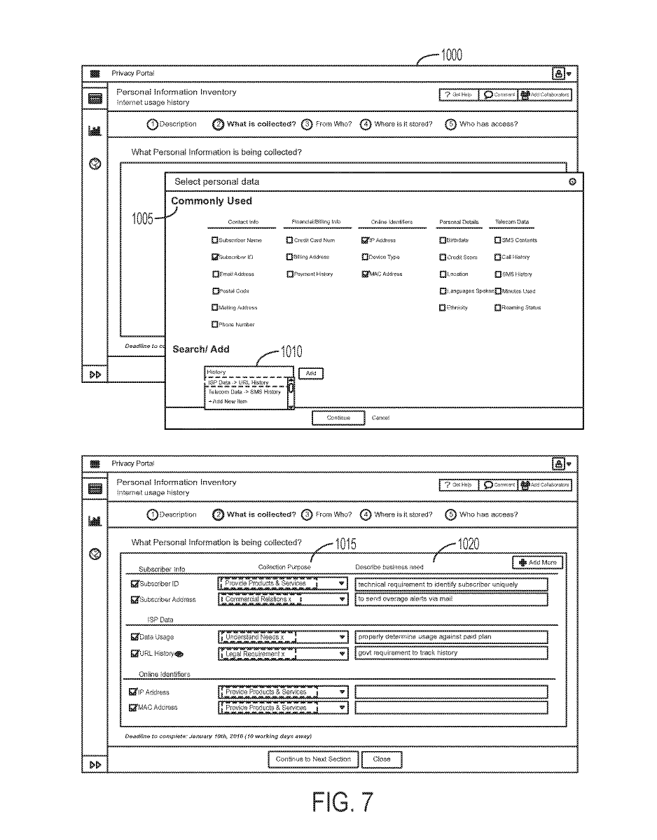

C. FIG. 7: What Personal Data is Collected

FIG. 7 depicts an exemplary screen display that shows a type of personal data that is collected as part of a particular campaign, in addition to a purpose of collecting such data, and a business need associated with the collection. As described in this disclosure, the system may be configured to monitor the user's inputs while providing this information regarding the particular privacy campaign to determine whether any of the submitted inputs may include one or more abnormal responses.

As shown in FIG. 7, after the first phase of campaign addition (i.e., description entry phase), the system may present the user (who may be a subsequently assigned business representative or privacy officer associated with the organization) with a dialog 1000 from which the user may enter in the type of personal data being collected. The user may, for example, enter the type of personal data using a suitable pointing device and keyboard, using a touchscreen, or using any other suitable input device.

For example, in FIG. 7, the user may select from Commonly Used 1005 selections of personal data that will be collected as part of the privacy campaign. This may include, for example, particular elements of an individual's contact information (e.g., name, address, email address), Financial/Billing Information (e.g., credit card number, billing address, bank account number), Online Identifiers (e.g., IP Address, device type, MAC Address), Personal Details (Birthdate, Credit Score, Location), or Telecommunication Data (e.g., Call History, SMS History, Roaming Status). The System 100 is also operable to pre-select or automatically populate choices—for example, with commonly-used selections 1005, some of the boxes may already be checked. The user may also use a search/add tool 1010 to search for other selections that are not commonly used and add another selection. Based on the selections made, the system may present the user with more options and fields. For example, in response to the user selecting “Subscriber ID” as personal data associated with the campaign, the user may be prompted to add a collection purpose under the heading Collection Purpose 1015, and the user may be prompted to provide the business reason why a Subscriber ID is being collected under the “Describe Business Need” heading 1020.

In various embodiments, as the user is selecting which types of personal data will be collected as part of the privacy campaign, the system is configured to monitor the user's selections. The system may monitor, for example: (1) whether the user selects and then unselects a particular type of personal data; (2) a number of times that the user selects and unselects a particular type of personal data; (3) an amount of time that the user places a pointing device adjacent to a particular type of personal data (e.g., mouses over the particular type of personal data) without selecting it; (4) an amount of time it takes the user to submit one or more responses regarding what type of personal data is collected; and or (5) any other suitable information related to the user's inputs or selections.

In particular embodiments, as discussed above, the system is configured to determine, based at least in part on the user's system inputs and one or more changes to the user's inputs, whether the user has provided one or more abnormal responses to the one or more questions. As may be understood from FIG. 7, for example, the system may be configured to determine that the user has provided one or more abnormal responses indicating what personal data is being collected. The system may determine that the user has made an abnormal response based on the fact the user had selected and then unselected several additional types of personal data prior to submitting the user's response. In this example, as described above with respect to the Privacy Assessment Modification Module at Step 420, the system may be configured to flag the question related to what personal information is being collected and add prompt the user to provide additional information. For example, the system may prompt the user to answer whether they are certain that a particular type of personal data will be collected as part of the privacy campaign. In various embodiments, the system may prompt the user to provide a collection purpose or business need for one or more types of personal data that the user had initially selected but later unselected. In still other embodiments, the system may prompt the user to provide a reason that the one or more types of personal data that the user had initially selected but later unselected will not be collected as part of the particular privacy campaign.

The system may further be configured to monitor, in any embodiment described herein, any input by the user as a response to any of the one or more prompts for additional information. For example, when prompting the user to provide the reason that the one or more types of personal data that the user had initially selected but later unselected will not be collected as part of the particular privacy campaign, the system may be configured to monitor the user's response (e.g., monitor the users text inputs) to determine whether the user provides a potentially abnormal response to the prompt for additional information as well (e.g., using any suitable technique describe herein).

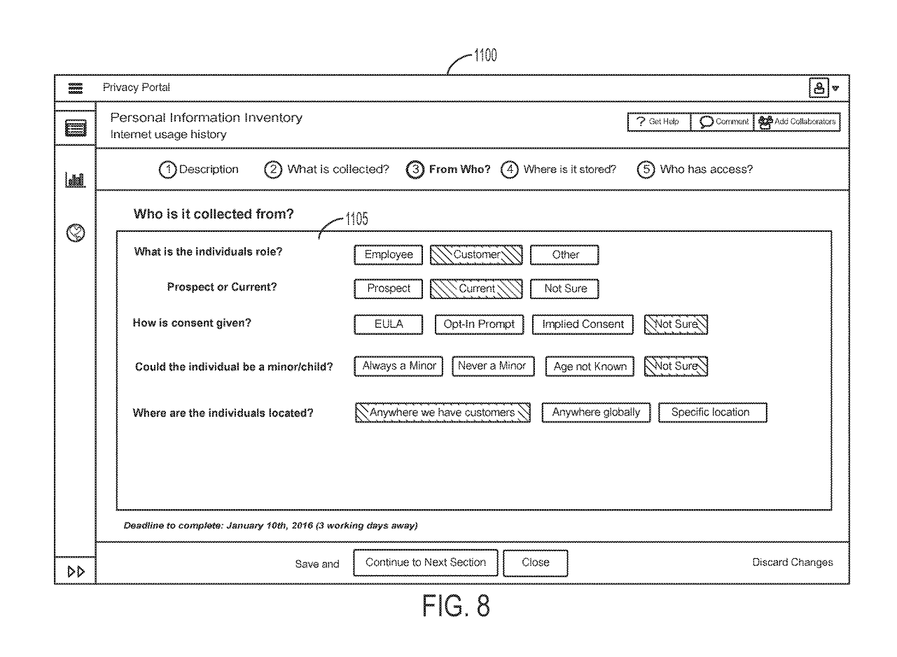

D. FIG. 8: Who Personal Data is Collected from

FIG. 8 depicts a screen display that shows who personal data is collected from in the course of the privacy campaign. As discussed herein, particular privacy campaigns may collect personal data from different individuals, and guidelines may vary for privacy campaigns based on particular individuals about whom data is collected. Laws may, for example, allow an organization to collect particular personal data, about their employees, that the organization is unable to collect about customers, and so on. In various embodiments, the user may provide the system with information about who data is collected from in the course of a particular privacy campaign using the interface shown in FIG. 8. As with the information regarding what personal data is collected described above with respect to FIG. 7, the system may be configured to monitor a user's selections via the user interface shown in FIG. 8 to determine whether the user has provided one or more abnormal responses.

As shown in the example of FIG. 8, the system may be configured to enable a user to enter and select information regarding who the personal data is gathered from as part of the privacy campaign. As noted above, the personal data may be gathered from, for example, one or more subjects. In the exemplary “Collected From” dialog 100, an organization user may be presented with several selections in the “Who Is It Collected From” section 1105. These selections may include whether the personal data is to be collected from an employee, customer, or other entity as part of the privacy campaign. Any entities that are not stored in the system may be added by the user. The selections may also include, for example, whether the data will be collected from a current or prospective subject (e.g., a prospective employee may have filled out an employment application with his/her social security number on it). Additionally, the selections may include how consent was given, for example, through an end user license agreement (EULA), on-line Opt-in prompt, implied consent, or an indication that the user is not sure. Additional selections may include whether the personal data was collected from a minor, and/or where the subject is located.

In various embodiments, as the user is selecting who data is collected from, the system is configured to monitor the user's selections. The system may monitor, for example: (1) whether the user selects and then unselects a particular type of individual; (2) a number of times that the user selects and unselects the particular type of individual; (3) an amount of time that the user places a pointing device adjacent to a particular type of individual (e.g., mouses over the particular type of personal data) without selecting it; (4) an amount of time it takes the user to submit one or more responses regarding who the personal data is collected from; and/or (5) any other suitable information related to the user's inputs or selections. The system may, in other embodiments, be further configured to monitor similar information related to the user's inputs or responses related to, for example: (1) whether an individual for whom data will be collected is a prospect or current employee or customer; (2) whether and how the individual for whom data will be collected provided consent for the collection; (3) whether the individual for whom data will be collected may be a minor or child; (4) where the individual for whom data will be collected is located; and/or (5) any other suitable information related to an individual from whom data is to be collected as part of the privacy campaign.

In particular embodiments, as discussed above, the system is configured to determine, based at least in part on the user's system inputs and one or more changes to the user's inputs, whether the user has provided one or more abnormal response to the one or more questions (e.g., related to who data is collected from). As may be understood from FIG. 8, for example, the system may be configured to determine that the user has provided one or more abnormal response to who data is being collected from based on determining that the user had selected and then unselected that the privacy campaign would collect data from prospective customers more than a threshold number of times (e.g., two times, three times, four times, or any suitable number of times.). In this example, the system may be configured to flag the question related to who personal data is collected from (e.g., and generate a notification regarding the flagged questions to provide to one or more individuals) and prompt the user to provide additional information. For example, the system may prompt the user to answer whether they are certain that the privacy campaign will not collect personal data from prospective customers. In various embodiments, the system may prompt the user to provide additional information relating to how consent would be given by prospective customers if personal data was, in fact, collected from prospective customer as part of the privacy campaign. As described above, the system may be configured to monitor any responses or inputs provided or submitted by the user in response to any prompts for additional information from the system (e.g., to determine whether the user's responses to the one or more prompts for additional information may include one or more potentially abnormal responses).

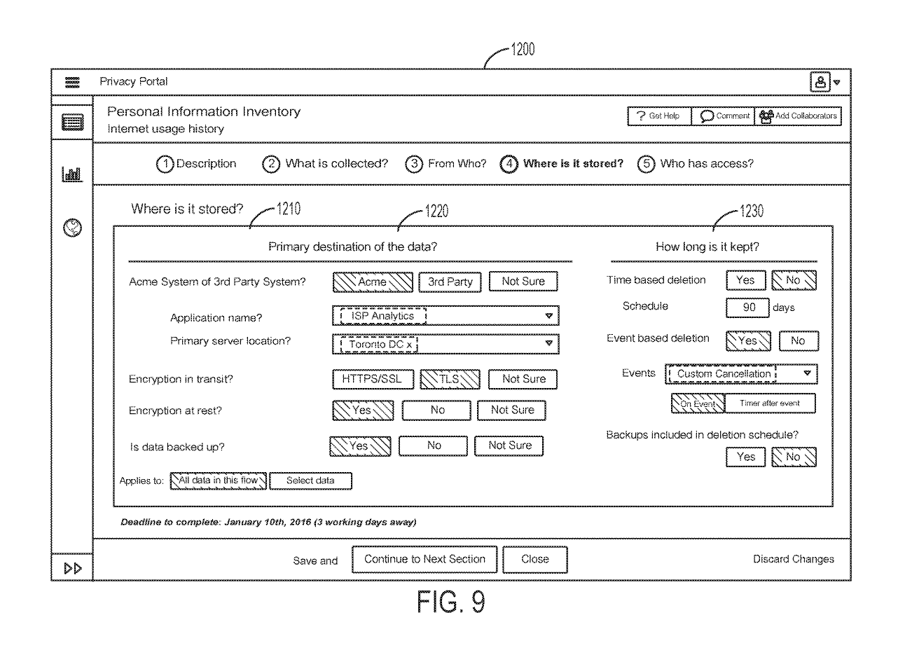

E. FIG. 9: Where is the Personal Data Stored

FIG. 9 depicts a screen display that shows where and how personal data is stored as part of the privacy campaign (e.g., on what physical server and in what location, using what encryption, etc.). As may be understood in light of this disclosure, particular privacy campaigns may collect different types of personal data, and storage guidelines may vary for privacy campaigns based on particular types of personal data collected and stored (e.g., more sensitive personal data may have higher encryption requirements, etc.). As may be understood in light of this disclosure, the system may be configured to substantially automatically modify one or more aspects of a particular privacy campaign in response to determining that a user has provided one or more abnormal responses to any of the questions regarding a privacy campaign discusses herein. For example, legal and/or industry regulations regarding the collection and storage of personal data may require a particular encryption level depending on what type of personal data is collected. In this example, the system may be configured to substantially automatically modify a type of encryption used to store personal data (e.g., to a stronger level of encryption) in response to the system determining that a user has provided one or more abnormal inputs when providing information regarding a particular privacy campaign. In this way, the system may, for example, alleviate or otherwise prevent exposure to potential fines or other sanctions as a result of insufficiently protecting collected data (e.g., by failing to meet one or more legal standards) until at least a time when the privacy campaign can be further reviewed to ensure that the information provided by the user was accurate.

FIG. 9 depicts an example “Storage Entry” dialog screen 1200, which is a graphical user interface that an organization user may use to indicate where particular sensitive information is to be stored within the system as part of a particular privacy campaign. From this section, a user may specify, in this case for the Internet Usage History campaign, the primary destination of the personal data 1220 and how long the personal data is to be kept 1230. The personal data may be housed by the organization (in this example, an entity called “Acme”) or a third party. The user may specify an application associated with the personal data's storage (in this example, ISP Analytics), and may also specify the location of computing systems (e.g., one or more physical servers) that will be storing the personal data (e.g., a Toronto data center). Other selections indicate whether the data will be encrypted and/or backed up.

In various embodiments, the system also allows the user to select whether the destination settings are applicable to all the personal data of the campaign, or just select data (and if so, which data). As shown in FIG. 9, the organization user may also select and input options related to the retention of the personal data collected for the campaign (e.g., How Long Is It Kept 1230). The retention options may indicate, for example, that the campaign's personal data should be deleted after a pre-determined period of time has passed (e.g., on a particular date), or that the campaign's personal data should be deleted in accordance with the occurrence of one or more specified events (e.g., in response to the occurrence of a particular event, or after a specified period of time passes after the occurrence of a particular event), and the user may also select whether backups should be accounted for in any retention schedule. For example, the user may specify that any backups of the personal data should be deleted (or, alternatively, retained) when the primary copy of the personal data is deleted.

In particular embodiments, the system is configured to prompt the user to provide additional information in response to determining that the user has provided one or more abnormal responses in providing the storage information described above. For example, in response to determining that the user has provided one or more abnormal inputs or responses, the system may be configured to prompt the user to provide additional information regarding where, how, and how long personal data will be stored as part of the privacy campaign. In some embodiments, the system may automatically generate recommendations to store the personal data in a location other than a location submitted by the user in response to determining that the user had initially selected a different response regarding where the information is stored.

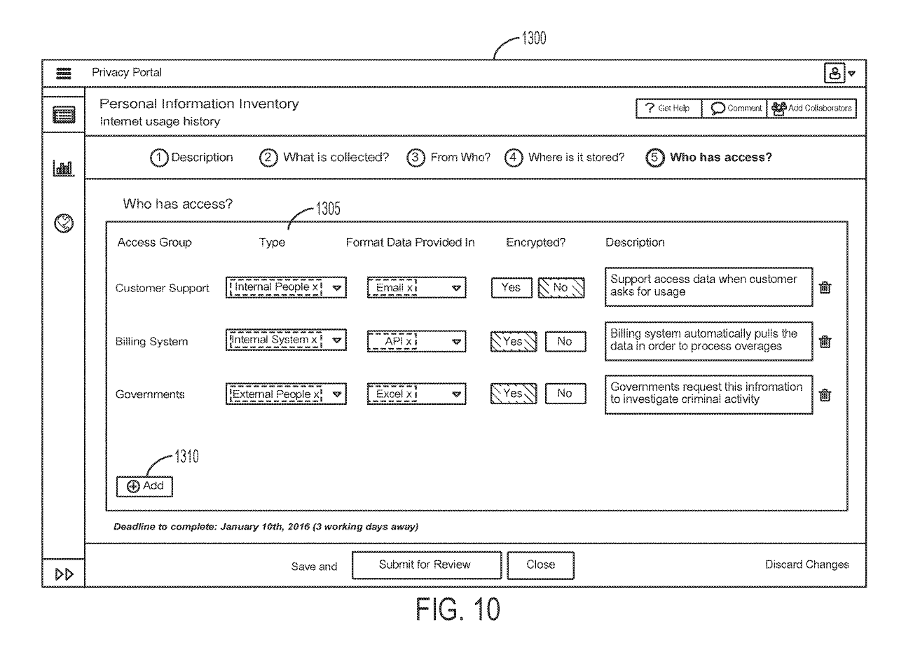

F. FIG. 10: Who and What Systems have Access to Personal Data

FIG. 10 depicts an exemplary screen display that shows who and what systems have access to personal data that is stored as part of the privacy campaign (e.g., what individuals, business groups, etc., have access to the personal data.). As may be understood in light of this disclosure, particular privacy campaigns may require different individuals, groups, or systems within an organization to access personal data to use it for the purpose for which it was collected (e.g., to run payroll, billing purposes, etc.). As may be understood in light of this disclosure, the system may be configured to monitor a user's inputs while the user provides information via the user interface regarding who has access to particular personal data as part of the privacy campaign. In further embodiments, the system may be further configured to substantially automatically flag one or more responses, prompt the user to provide additional information, or modify one or more aspects of a particular privacy campaign in response to determining that the user has provided one or more abnormal responses.

FIG. 10 depicts an example Access entry dialog screen 1300 which an organization user may use to input various access groups that have permission to access particular personal data that makes up part of the privacy campaign. As part of the process of adding a campaign or data flow, the user may specify particular access groups in the “Who Has Access” section 1305 of the dialog screen 1300. In the example shown, the Customer Support, Billing, and Governments groups within the organization may be able to access the Internet Usage History personal data collected by the organization as part of the privacy campaign. Within each of these access groups, the user may select the type of each group, the format in which the personal data may be provided, and whether the personal data is encrypted. The access level of each group may also be entered. The user may add additional access groups via the Add Group button 1310.

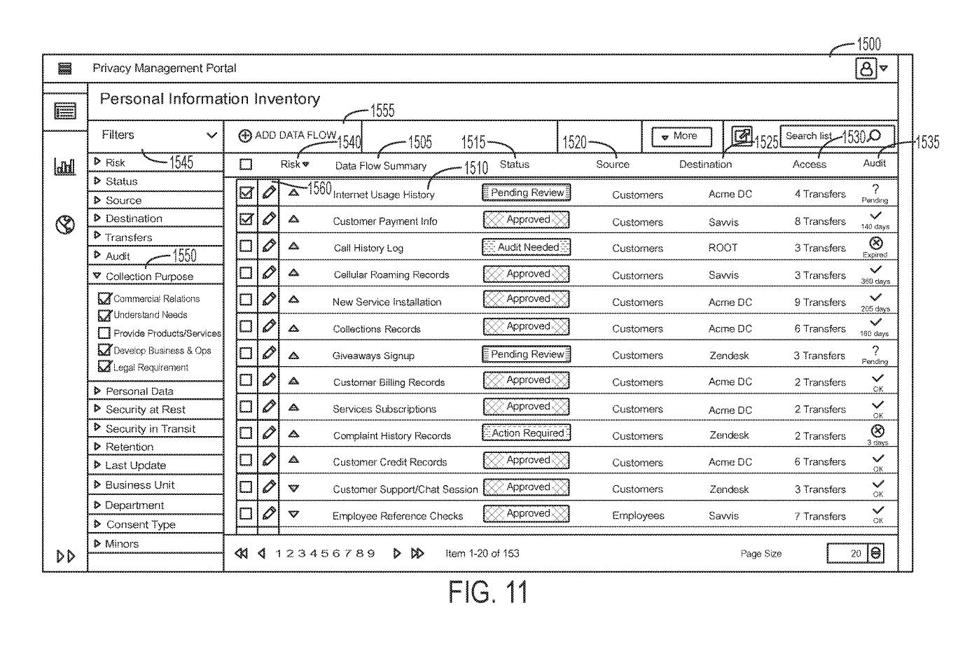

H: FIG. 11: Campaign Inventory Page

After new campaigns have been added, for example using the exemplary processes explained in regard to FIGS. 5-10, the system may generate a listing of privacy campaigns, including privacy campaigns for which one or more responses have been flagged based on one or more abnormal responses. The chief privacy officer, or another privacy office representative, for example, may be the only user that may view all campaigns. A listing of all of the campaigns within the system may be viewed on, for example, inventory page 1500 (see below).

FIG. 11 depicts an example embodiment of an inventory page 1500 that may be generated by the system. The inventory page 1500 may be represented in a graphical user interface. Each of the graphical user interfaces (e.g., webpages, dialog boxes, etc.) presented in this application may be, in various embodiments, an HTML-based page capable of being displayed on a web browser (e.g., Firefox, Internet Explorer, Google Chrome, Opera, etc.), or any other computer-generated graphical user interface operable to display information, including information having interactive elements (e.g., an iOS, Mac OS, Android, Linux, or Microsoft Windows application). The webpage displaying the inventory page 1500 may include typical features such as a scroll-bar, menu items, as well as buttons for minimizing, maximizing, and closing the webpage. The inventory page 1500 may be accessible to the organization's chief privacy officer, or any other of the organization's personnel having the need, and/or permission, to view personal data.

Still referring to FIG. 11, inventory page 1500 may display one or more campaigns listed in the column heading Data Flow Summary 1505, as well as other information associated with each campaign, as described herein. Some of the exemplary listed campaigns include Internet Usage History 1510 (e.g., described above with respect to FIGS. 4-9), Customer Payment Information, Call History Log, Cellular Roaming Records, etc. A campaign may represent, for example, a business operation that the organization is engaged in and may require the use of personal data, which may include the personal data of a customer. In the campaign Internet Usage History 1510, for example, a marketing department may need customers' on-line browsing patterns to run certain types of analytics.

The inventory page 1500 may also display the status of each campaign, as indicated in column heading Status 1515. Exemplary statuses may include “Pending Review”, which means the campaign has not been approved yet, “Approved,” meaning the personal data associated with that campaign has been approved, “Audit Needed,” which may indicate that a privacy audit of the personal data associated with the campaign is needed, and “Action Required,” meaning that one or more individuals associated with the campaign must take some kind of action related to the campaign (e.g., completing missing information, responding to an outstanding message, etc.). In certain embodiments, the approval status of the various campaigns relates to approval by one or more third-party regulators as described herein.

The inventory page 1500 of FIG. 11 may list the “source” from which the personal data associated with a campaign originated, under the column heading “Source” 1520. As an example, the campaign “Internet Usage History” 1510 may include a customer's IP address or MAC address. For the example campaign “Employee Reference Checks”, the source may be a particular employee.

The inventory page 1500 of FIG. 11 may also list the “destination” of the personal data associated with a particular campaign under the column heading Destination 1525. Personal data may be stored in any of a variety of places, for example, on one or more databases 140 that are maintained by a particular entity at a particular location. Different custodians may maintain one or more of the different storage devices. By way of example, referring to FIG. 10, the personal data associated with the Internet Usage History campaign 1510 may be stored in a repository located at the Toronto data center, and the repository may be controlled by the organization (e.g., Acme corporation) or another entity, such as a vendor of the organization that has been hired by the organization to analyze the customer's internet usage history. Alternatively, storage may be with a department within the organization (e.g., its marketing department).

On the inventory page 1500, the Access heading 1530 may show the number of transfers that the personal data associated with a campaign has undergone. This may, for example, indicate how many times the data has been accessed by one or more authorized individuals or systems.

The column with the heading Audit 1535 shows the status of any privacy audits associated with the campaign. Privacy audits may be pending, in which an audit has been initiated but yet to be completed. The audit column may also show for the associated campaign how many days have passed since a privacy audit was last conducted for that campaign. (e.g., 140 days, 360 days). If no audit for a campaign is currently required, an “OK” or some other type of indication of compliance (e.g., a “thumbs up” indicia) may be displayed for that campaign's audit status. The audit status, in various embodiments, may refer to whether the privacy campaign has been audited by a third-party regulator or other regulator as required by law or industry practice or guidelines. As discussed above, in any embodiment described herein, the system may be configured to substantially automatically adjust an audit schedule for one or more privacy campaigns associated with a particular organization based at least in part on that organization's privacy maturity.

The example inventory page 1500 may comprise a filter tool, indicated by Filters 1545, to display only the campaigns having certain information associated with them. For example, as shown in FIG. 11, under Collection Purpose 1550, checking the boxes “Commercial Relations,” “Provide Products/Services”, “Understand Needs,” “Develop Business & Ops,” and “Legal Requirement” will result the display under the Data Flow Summary 1505 of only the campaigns that meet those selected collection purpose requirements.

From example inventory page 1500, a user may also add a campaign by selecting (i.e., clicking on) Add Data Flow 1555. Once this selection has been made, the system initiates a routine (e.g., a wizard) to guide the user in a phase-by-phase manner through the process of creating a new campaign. An example of the multi-phase GUIs in which campaign data associated with the added privacy campaign may be input and associated with the privacy campaign record is described in FIGS. 5-10 above.

From the example inventory page 1500, a user may view the information associated with each campaign in more depth, or edit the information associated with each campaign. To do this, the user may, for example, click on or select the name of the campaign (i.e., click on Internet Usage History 1510). As another example, the user may select a button displayed on the screen indicating that the campaign data is editable (e.g., edit button 1560).

### CONCLUSION

Although embodiments above are described in reference to various privacy compliance monitoring systems, it should be understood that various aspects of the system described above may be applicable to other privacy-related systems, or to other types of systems, in general.

While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Many modifications and other embodiments of the invention will come to mind to one skilled in the art to which this invention pertains having the benefit of the teachings presented in the foregoing descriptions and the associated drawings. While examples discussed above cover the use of various embodiments in the context of operationalizing privacy compliance and monitoring user inputs related to privacy campaigns, various embodiments may be used in any other suitable context. For example, various systems and methods described herein may be applied within the context of any other type of data-gathering effort, such as any other type of data-gathering effort that would gather data using questionnaires. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer-implemented data processing method for monitoring one or more user inputs while a user provides one or more responses to one or more questions in a computerized privacy questionnaire, the method comprising:
receiving, by one or more processors, an indication that the user is submitting the one or more responses to the computerized privacy questionnaire;
in response to receiving the indication, actively monitoring, by one or more processors, one or more system inputs from the user, the one or more system inputs comprising one or more submitted inputs and one or more unsubmitted inputs;
storing, in computer memory, by one or more processors, an electronic record of the one or more system inputs;
analyzing, by one or more processors, the one or more submitted inputs and one or more unsubmitted inputs to determine one or more changes to the one or more responses prior to submission, by the user, of the one or more responses;
determining, by one or more processors, based at least in part on the one or more inputs and the one or more changes to the one or more response, whether the user has provided one or more responses comprising one or more abnormal responses; and
at least partially in response to determining that the user has provided one or more abnormal responses, automatically flagging the one or more questions in memory.

2. The computer-implemented method of claim 1, wherein:
actively monitoring the one or more system inputs comprises:
recording a first keyboard entry into a first freeform text box on a graphical user interface; and
recording a second keyboard entry into the first freeform text box;
the one or more submitted inputs comprise the second keyboard entry; and
the one or more unsubmitted inputs comprise the first keyboard entry.

3. The computer-implemented method of claim 2, wherein analyzing the one or more submitted inputs and one or more unsubmitted inputs to determine one or more changes to the one or more responses prior to submission comprises comparing the first keyboard entry to the second keyboard entry.

4. The computer-implemented method of claim 3, wherein determining that the user has provided one or more responses comprising one or more abnormal responses comprises determining whether the first keyboard entry has a meaning that differs from the second keyboard entry.

5. The computer-implemented method of claim 4, wherein the system is configured for:
prompting the user to answer at least one follow up question in response to submission, by the user, of one or more responses comprising the first keyboard entry;
determining that the first keyboard entry has a meaning that at least partially differs from the second keyboard entry;
determining that the user has provided one or more abnormal responses in response to determining that the first keyboard entry has a meaning that at least partially differs from the second keyboard entry; and
at least partially in response to determining that the user has provided one or more abnormal responses, prompting the user to answer the at least one follow up question.

6. The computer-implemented method of claim 1, wherein:
actively monitoring the one or more system inputs comprises actively monitoring and recording a position of a pointer device used by the user to provide the one or more responses.

7. The computer-implemented method of claim 1, wherein analyzing the one or more submitted inputs and one or more unsubmitted inputs to determine one or more changes to the one or more responses prior to submission comprises determining a number of times the user changed a response to a particular one of the one or more questions.

8. The computer-implemented method of claim 7, wherein determining whether the user has provided one or more abnormal responses comprises determining whether the number of times the user changed the response to the particular one of the one or more questions more than a threshold number of times.

9. The computer-implemented method of claim 8, wherein the threshold number of times is two times.

10. The computer-implemented method of claim 1, wherein the system is further configured for:
at least partially in response to determining that the user has provided one or more abnormal responses, modifying, by one or more processors, the questionnaire to include at least one follow up question.

11. A computer-implemented data processing method for monitoring one or more system inputs by a user associated with a particular privacy campaign for one or more abnormal inputs, the method comprising:
receiving the one or more system inputs, from the user, via one or more input devices, wherein the one or more system inputs comprise one or more submitted inputs and one or more unsubmitted inputs;
storing, by one or more processors, a record of the one
more system inputs;
analyzing, by one or more processors, the one or more submitted inputs and the one or more unsubmitted inputs to determine one or more changes to the one or more inputs;
determining, by one or more processors, based at least in part on the one or more system inputs and the one or more changes, whether the one or more system inputs comprise one or more abnormal inputs; and
in response to determining that the user has provided one or more abnormal inputs, automatically flagging the one or more inputs in the record of the one or more system inputs.

12. The computer-implemented data processing method of claim 11, wherein the one or more input devices are selected form the group consisting of:
a keyboard;
a mouse; and
a touch-screen.

13. The computer-implemented method of claim 11, wherein:
the one or more system inputs comprises one or more system inputs via a graphical user interface comprising one or more questions related to the particular privacy campaign.

14. The computer-implemented data processing method of claim 13, the method further comprising modifying the one or more questions to include at least one follow up question in response to determining that the one or more system inputs comprise one or more abnormal inputs.

15. The computer-implemented data processing method of claim 14, wherein:
the one or more system inputs comprise:
a first input in response to a first question of the one or more questions; and
a second input in response to the first question of the one or more questions;
the one or more submitted inputs comprise the first input;
the one or more submitted inputs comprise the second input; and
analyzing the one or more submitted inputs and the one or more unsubmitted inputs to determine the one or more changes to the one or more inputs comprises comparing the first input to the second input.

16. The computer-implemented data processing method of claim 15, wherein:
the one or more changes comprise an amount of time between receiving the first system input, the second system input, and a submitted response to the first question.

17. A computer-implemented data processing method for analyzing one or more changes to one or more responses to a computerized privacy questionnaire by a user to identify one or more abnormal responses, the method comprising:
receiving, by one or more processors, an indication that the user is submitting the one or more responses to the computerized privacy questionnaire;
in response to receiving the indication, actively monitoring, by one or more processors, the one or more responses, the one or more responses comprising one or more submitted responses and one or more unsubmitted responses;
storing, in computer memory, by one or more processors, an electronic record of the one or more system responses;
analyzing, by one or more processors, the one or more submitted responses and one or more unsubmitted responses to determine one or more changes to the one or more responses prior to submission, by the user, of the one or more responses;
determining, by one or more processors, based at least in part on the one or more responses and the one or more changes to the one or more responses, whether the user has provided one or more abnormal responses; and
at least partially in response to determining that the user has provided one or more abnormal responses, automatically flagging the one or more responses in memory.

18. The computer-implemented data processing method of claim 17, wherein actively monitoring the one or more responses comprises receiving a first unsubmitted response and a second submitted response.

19. The computer-implemented data processing method of claim 18, wherein analyzing, the one or more submitted responses and one or more unsubmitted responses to determine one or more changes to the one or more responses prior to submission comprises comparing the first submitted response to the second submitted response.

20. The computer-implemented data processing method of claim 18, wherein analyzing, the one or more submitted responses and one or more unsubmitted responses to determine one or more changes to the one or more responses prior to submission comprises comparing a number of times the user alternated between the first submitted response and the second submitted response.
